(19) United States
(12) Patent Application Publication
(10) Pub. No.: US 2021/0213766 A1
(43) Pub. Date: Jul. 15, 2021

(54) LIGHT GUIDES

(71) Applicant: Hewlett-Packard Development Company, L.P., Spring, TX (US)

(72) Inventors: Li Fang Lim, Singapore (SG); Swee Siang Lim, Singapore (SG)

(73) Assignee: Hewlett-Packard Development Company, L.P., Spring, TX (US)

(21) Appl. No.: 17/054,510

(22) PCT Filed: Oct. 1, 2018
(86) PCT No.: PCT/US2018/053688

§ 371 Date: Nov. 10, 2020

(51) Int. Cl. B41J 29/38; G09F 13/04

(52) U.S. Cl. CPC B41J 29/38; G09F 2013/0481; G09F 13/04

(57) ABSTRACT

Examples of light guides for printing devices are described. In an example, a light guide may include a substrate having a first end to receive light emitted from a light source. The light guide may also include a second end to output diffused light, based on the light received at the first end. Further, the substrate has a bend profile disposed such that the light entering the substrate through the first end is reflected towards the second end by an inner surface of the bend. In an example, a ratio of a length of the substrate to a width of the diffused light at the second end is in a range of about 1:6 to about 1:12.

### BACKGROUND

Printing devices, such as laser printers, ink-jet printers, and so on, may include a light guide. The light guide transmits light emitted from a light source to illuminate a light bar. The light bar may display light-based patterns or animations to indicate operational states of the printing device. For example, a light pattern may indicate a switching ON state, a switching OFF state, of the printing devices.

### BRIEF DESCRIPTION OF DRAWINGS

The following detailed description references the drawings, wherein:

FIG. 1A illustrates a sectional view of a light guide for a printing device, according to an example:

FIG. 1B illustrates a cross-sectional view of the light guide for a printing device, according to an example;

FIG. 2 illustrates another sectional view of a light guide for a printing device, according to an example;

FIG. 3 illustrates a sectional view of a printing device, according to an example; and

FIG. 4 illustrates a sectional view of a printing device, according to an example.

### DETAILED DESCRIPTION

Printing devices include a light source, such as single colored light emitting diodes (LEDs), for emitting light to illuminate a light bar of the printing device. The light bar may be a bar to provide a visual indication. For example, the light bar may be used to indicate an operational state of the printing device to a user of the printing device. Thus, the light bar is often placed at a front of the printing device so as to be clearly visible to the user. The light emitted from the LEDs thus travels a certain distance through a light guide to illuminate the light bar. Some of the emitted light may get refracted or scattered to the surrounding. In addition, the light entering the light guide may not reach the light bar as some part of the emitted light may be refracted from or scattered in the light guide.

At times, uniform light distribution at the end of alight guide (e.g., at the light bar) may be achieved by using significantly long light guides or using a greater number of LEDs. However, as printing devices become compact, there is pressure to reduce the dimensions of various components of the printing devices. Thus, when the size of the light guide reduces, the light emitted from the LEDs may have insufficient distance before reaching the light bar to yield desired light uniformity. To provide a uniform illumination with a small light guide, number of LEDs may be increased, and the LEDs may be placed relatively close to each other. However, an increased number of closely placed LEDs when lit together may result in hot spots in the printing device, which may cause damage to electrical components that may be placed near to the LEDs. Using an increased number of LEDs also increases the cost of the user interface. There may be a desire, therefore, for a light guide that can achieve uniform light distribution within a compact printing device without an increased number of closely placed LEDs.

The present subject matter relates to light guides and printing devices implementing such light guides. As per the present subject matter, a printing device includes limited number of LEDs to illuminate a wide light bar in a uniform manner. Further, the light guide includes a bend profile, such as to provide sufficient distance for light to travel from a light source in order to illuminate entire width of the light bar (e.g., uniform light distribution).

In an example implementation, a printing device includes a light bar to indicate an operational state of the printing device. The printing device further includes a light source having a limited number of light-emitting diodes (LEDs) of same pitch. Thus, the printing device uniformly illuminates a light bar with limited number of LEDs. In an example, the LEDs are side-firing LEDs and thus ensures that the light emitted from the LEDs enters the light guide. The side-firing LEDs emit light through a side of an LED.

Further, the printing device includes a light guide to transmit the light emitted from the light source to the light bar of the printing device. The light guide includes a substrate having a first end and a second end. The first end is to receive light emitted from the light source and the second end is to output diffused light to illuminate the light bar. Further, the substrate has a bend profile such that the light entering the substrate through the first end is reflected towards the second end by an inner surface of a bend. The light guide thus increases a length that the light has to travel before reaching the light bar. In an aspect, a ratio of a length ‘L’ of the substrate to a length ‘L_{B}’ of the light bar is in a range of 1:6 to about 1:12. For example, a 19 millimeters long substrate may illuminate the light bar having a length from about 117 mm to about 225 mm.

Accordingly, the present subject matter enables uniform illumination of a light bar with limited number of LEDs to indicate the operational state of the printing device in an efficient manner.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

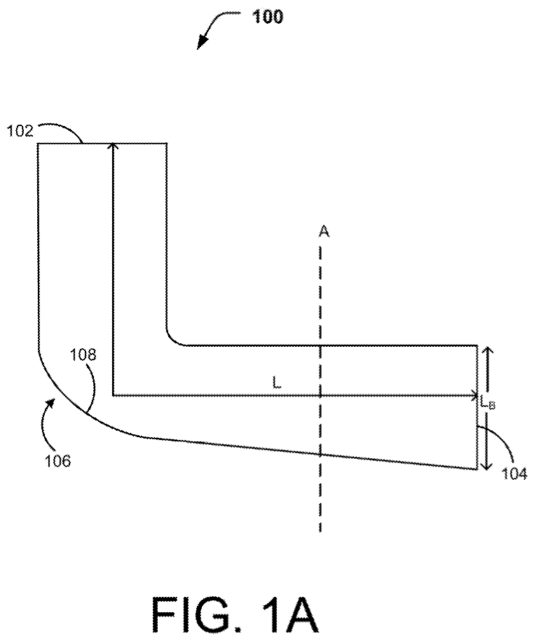

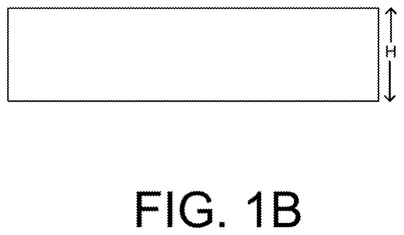

The manner in which the light guide and the systems implementing the light guide are implemented are explained in detail with respect to FIGS. 1A-4. While aspects of described light guide and printing devices can be implemented in any number of different computing systems, environments, and/or implementations, the examples are described in the context of the following system(s). It is to be noted that drawings of the present subject matter shown here are for illustrative purposes and are not drawn to scale.

FIG. 1A illustrates a sectional view of a light guide 100 for a printing device (not shown), according to an example. The light guide 100 may be implemented in the printing device to receive light from a light source (not shown) and transmit the light to illuminate a surface area, such as a light bar (not shown). Although, the description herein is provided with respect to a printing device, the light guide 100 may be implemented in various other devices. Examples of the devices include, but are not limited to, an automotive lighting, commercial displays, computer monitors, and televisions.

The light guide 100 is formed of a substrate having a first end 102 to receive light emitted from the light source. In an example, the light source may be a plurality of light emitting diodes (LEDs). The substrate may be placed along an edge of the plurality of the LEDs to receive the light entering the light guide 100. Further, the substrate includes a second end 104 to output diffused light, based on the light received at the first end 102. For example, the second end 104 may be coupled to a diffuser to diffuse the light towards the light bar of the printing device.

Further, the substrate may include a bend profile 106 between the first end 102 and the second end 104. In an example, the bend profile 106 may be a concave inner profile. The light entering the light guide 100 through the first end 102 is reflected towards the second end 104 by the bend profile 106. In an example, the light entering through the first end 102 is incident on an inner surface 108 of the bend profile 106 for being directed towards the second end 104. The bend profile 106 facilitates in directing the reflected incident light within the substrate towards the second end 104. In an aspect, a point on a curve of the bend profile 106 subtends an angle θ with respect to a side wall (not shown) of the light guide 100. The bend profile 106 provides sufficient length to the light to travel before being transmitted to the light bar. Further, the substrate of the light guide 100 may have a length ‘L’ of about 19 millimeters from the first end 102 to the second end 104. In an example, the substrate having the length ‘L’ of 19 mm may diffuse the light having a width of about 117 mm to about 225 mm, at the second end 104. Accordingly, a ratio of the length ‘L’ of the substrate to a width ‘L_{B}’ of the diffused light at the second end 104 may be in a range of about 1:6 to about 1:12. Thus, the light guide 100 facilitates in illuminating a wider area with respect to a distance travelled by the light within the light guide 100.

The light guide 100 may be a solid light guide. In an example implementation, the light guide 100 may be formed as a single piece. In case of the single piece construction, the light guide 100 may be molded to provide a shape based on the application of the light guide 100. Alternatively, the light guide 100 may include multiple pieces that are connected by various techniques, such as adhesives, fasteners, and so on.

Further, an outer surface (not shown) of the bend profile 106 may be polished with a diamond puff polish to provide the reflective properties. In an example, a reflective sheet may be pasted on the outer surface of the bend profile 108. In another example, the substrate may be made of the plastic material and the end profile 106 may be a mirror.

In an example, the light guide 100 may have an L-shape, a Z-shape, or, any other shape where the first end 102 and the second end 104 define a bend profile in-between. Thus, the light guide 100 provides sufficient distance to the light entering through the first end 102 before being transmitted to the light bar through the second end 104, resulting in uniform illumination of the light bar.

FIG. 1B illustrates a cross-sectional view of the light guide 100, according to an example. The cross-section of the light guide 100 is taken along an axis A, as depicted in FIG. 1A. Referring to FIG. 1B, a height ‘H’ of the light guide 100 across the cross section is a thickness of the light guide 100. In an example, the light guide 200 may have a thickness of about 1.8 mm. Thus, the light guide 100 of the present subject matter may be easily fitted within a compact printing device.

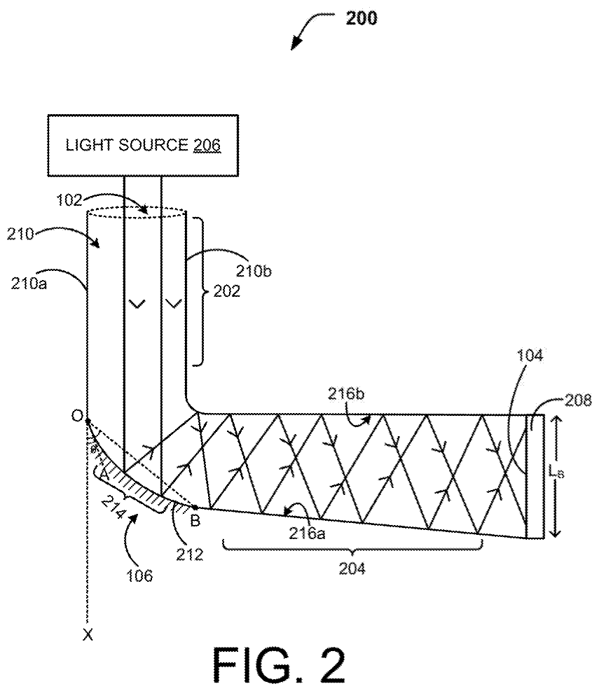

The above aspects and further details are described in conjunction with FIG. 2. FIG. 2 illustrates another sectional view of a light guide 200, according to an example. In an example, the light guide 200 may be similar to the light guide 100. The light guide 200 thus includes the first end 102, the second end 104, and the bend profile 106 between the first end 102 and the second end 104. Further, the light guide 200 may be formed of a glass material, a plastic material, a quartz material, a silica material, or any other translucent solid material. In an example, the light guide 200 may be made of a styrene-acrylonitrile (SAN) material with variable amounts of diffusing agents. For example, the light guide 200 may have 0.4% diffusing agent, 0.5% diffusing agent, 0.8% diffusing agent, or 1.5% diffusing agent. SAN material offers thermal resistance and has a visible transmittance of greater than 90%.

In an example, the substrate of the light guide 200 may include a first portion 202 and a second portion 204. The first portion 202 may have the first end 102 to receive light emitted from a light source 206. Further, the second portion 204 may be a diffuser having the second end 104 to output the diffused light to illuminate a light bar 208. In an example implementation, the first portion 202 may have a length of about 8.2 mm and the second portion 204 may have a length of about 10.8 mm. Thus, the light guide 200 may have a total length of about 19 mm. Although, the first portion 202 and the second portion 204 are mentioned to have different lengths, the first portion 202 and the second portion 204 may have same length.

In an example, the light guide 200 may be formed so as to be fitted in a printing device (not shown) where the light source 206 is placed far from the light bar 208 to be illuminated. In an example, the light source 206 may include a plurality of light emitting diodes (LEDs). The light guide 200 allows the light emitted from the light source 206 to travel a distance to entirely illuminate the light bar 208. In an example, a length ‘L_{B}’ of the light bar 208 may be about 225 mm. Although FIG. 2 depicts an L-shaped light guide 200, the light guide 200 may have an S-shape, a Z-shape, and the like. In an aspect, the light guide 200 and the light source 206 is coupled to a printed circuit board (PCB) (not shown) of the printing device. In an example, the light guide 200 may have a spherical body or a cuboidal body.

In an example implementation, the light emitted from the light source 206 is received at the first end 102 of the light guide 200. In an example, the light source 206 may be placed adjacent to the first end 102. In an example, the substrate defines a wall 210 having side wall 210a and 210b. The light emitted by the light source 206 enters through the first end 102 of the first portion 202 and travels along the wall 210 in a direction parallel to the side walls 210a and 210b of the substrate. Further, the light received at the first end 102 may get diffused towards the light bar 208 through the second end 104 formed at the second portion 204. In an example, the diffuser of the light guide 200 facilitates an even distribution of the light received at the first end 102 across the light bar 208 to reduce dark spots when viewed by a user of the printing device.

As mentioned previously, the light guide 200 also includes the bend profile 106 formed between the first portion 202 and the second portion 204 of the light guide 200. In an example of the present subject matter, an outer surface of the bend profile 106 may be polished as per grades A1 and A2 of the Standards of the Plastic Industry (SPI) to provide the reflective property.

In an aspect of the present subject matter, the bend profile 106 includes a curve 212 at a junction of the first portion 202 and the second portion 204. In an example implementation, each point on the curve 212 subtends an angle θ with respect to the side wall 210a of the first portion 202. For example, the angle θ may be in a range of about 43 degrees to about 65 degrees. As depicted in FIG. 2, points A and B on the curve 212 subtends an angle θ with respect to the side wall 210a of the first portion 202. Further, the angle θ may gradually increase across a length of the bend profile 106. For example, the bend profile 106 may have a length of about 1.61 mm. In an example, an angle formed between points XOA is in a range of about 43 degrees to about 47 degrees. In another example, an angle formed between points XOB is in a range of about 63 degrees to about 65 degrees.

In operation, the light emitted from the light source 206 is received by the first portion 202 of the light guide 200. As light travels in straight line, the light received through the first end 102 formed at the first portion 202 is incident on the inner surface 108 of the bend profile 106. In an example, a reflective sheet is formed or attached on the outer surface 214 of the bend profile 106. As a result, the bend profile 106 prevents loss of the incident light by causing total internal reflection of the incident light. In addition, the bend profile 106 facilitates in maintaining uniform intensity of the reflected light.

The light reflected from the bend profile 106 is directed towards the second portion 204 of the light guide 200. In an example, the light beams reflected from the bend profile 106 strikes the inner walls 216a and 216b of the second member 204. For example, the reflected light beams may scatter or diffuse between the inner walls 216a and 216b of the second member 204, before being output from the second end 104, to cause the entire length of the light bar 208 to be uniformly illuminated.

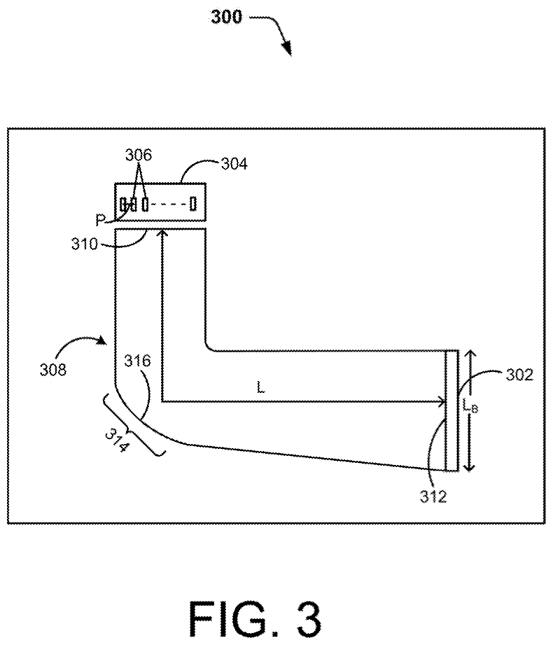

FIG. 3 illustrates a sectional view of a printing device 300, according to an example. In an implementation, the printing device 300 may include a light bar 302 to indicate an operational state of the printing device 300. For example, a light pattern may be displayed through the light bar 302 to indicate a switching ON state, a switching OFF state, an error state, etc., of the printing device 300. In an example, the light bar 302 may be made of a styrene-acrylonitrile (SAN) material with about 0.8% diffusing agent. As the operational state of the printing device 300 is displayed to a user of the printing device 300, the light bar 302 may be placed at a front of the printing device 300. In an example, the light bar 302 may have a length ‘L_{B}’ of about 225 mm. In an implementation, the light bar 302 may be coupled to a printed circuit board (PCB) (not shown) of the printing device 300.

Further, the printing device 300 may include a light source 304 having light emitting diodes (LEDs) 306. In an example, the printing device 300 may include three LEDs, five LEDs, seven LEDs, nine LEDs, eleven LEDs, and so on. In an implementation, a ratio of the number of LEDs 306 to a length of the light bar 302 is in a range of about 1:25 to about 1:30. For example, when the light source 304 includes three LEDs 306, the length of the light bar 302 may be about 117 mm. In another example, when the light source 304 includes five LEDs 306; the length of the light bar 302 may be about 153 mm, and so on.

In an example, the LEDs 306 may have a same pitch ‘P’ of about 18 mm. Further, each LED of the LEDs 306 may have a width of about 3.2 mm. The same pitch between a limited number of LEDs facilitates in evenly distributing the light on the light bar 302. In an example implementation, the plurality of LEDs 306 comprises side-firing LEDs such that the light emitted from the plurality of LEDs 306 is focused directly in a light guide, such as light guide 100 or 200. Furthermore, the LEDs 306 may be Red, Green, and Blue (RGB) LEDs. Accordingly, the LEDs 306 facilitates in displaying different operational states of the printing device 300 using a combination of the RGB LEDs. Although the above description describes the LEDs 306 as side-firing LEDs, top-firing LEDs may also be employed in the printing device 300.

In an example implementation, the printing device 300 may include a light guide 308 to transmit the light emitted from the light source 304 to the light bar 302. In an example, the light guide 308 may be similar to the light guides 100 and 200 as described with reference to FIGS. 1 and 2. The light guide 308 may be made of a plastic material, such as a Styrene acrylonitrile (SAN) material. The light guide 308 may have an L-shape with a length ‘L’ of about 19 mm. In an example, a ratio of the length ‘L’ of the light guide 308 to the length ‘L_{B}’ of the light bar 302 is in a range of about 1.6 to about 1:12.

The light guide 308 may be formed of a substrate having a first end 310 to receive light emitted from the light source 304. The first end 310 may be placed along an edge of the LEDs 306 such that the light emitted from the light source 304 enters the light guide 308. Further, the light guide 308 includes a second end 312 to output diffused light, based on the light received at the first end 310, to illuminate the light bar 302 of the printing device 300.

In an example, the light guide 308 may include a bend profile 314 between the first end 310 and the second end 312. In operation, the light entering the light guide 308 through the first end 310 is incident on an inner surface 316 of the bend profile 314 for being reflected towards the second end 312. The bend profile 314 therefore facilitates in focusing the reflected incident light within the substrate 308 towards the second end 312. In the present example, a point on a curve of the bend profile 314 subtends an angle θ (not shown) with respect to a side wall (not shown) of the light guide 308.

Thus, the light guide 308 facilitate in illuminating a wider surface area of the light bar 302 based on the light emitted by a limited number of LEDs. In addition, the light guide 308 provides sufficient length for the light to travel before being transmitted to the light bar 302.

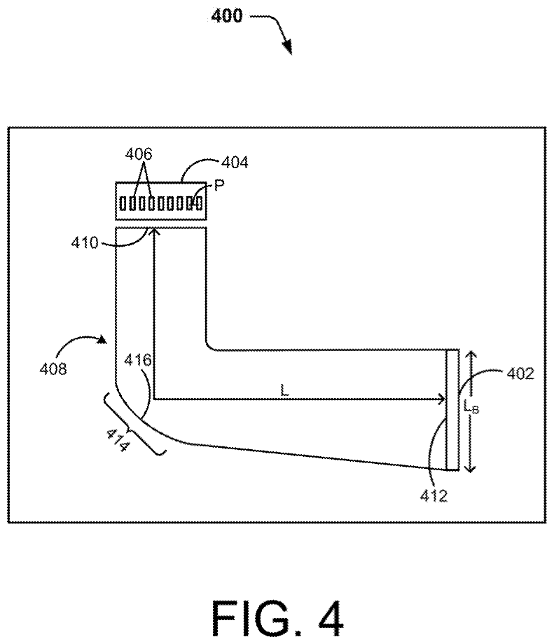

FIG. 4 illustrates a sectional view of an electronic device 400, according to an example. In an implementation, the printing device 400 may include a light bar 402 to indicate an operational state of the printing device 400. The light bar 402 is similar to the light bar 302 as described with reference to FIG. 3. In an example, the light bar 402 may have a length ‘L_{B}’ of about 225 mm. In an implementation, the light bar 402 may be coupled to a printed, circuit board (PCB) (not shown) of the printing device 400. In an example, the PCB may be a two layered PCB and the light bar 402 may be coupled to one of the layers of the two-layered PCB.

Further, the printing device 400 may include a light source 404 having nine light-emitting diodes (LEDs) 406. In an example implementation, the nine LEDs 406 have a same pitch ‘P’ of about 18 mm. The pitch ‘P’ of the LEDs is a distance from a center of an LED to the center of an adjacent LED. Further, each LED of the plurality of LEDs 406 may have a width of about 3.2 mm. In an example implementation, the nine LEDs 406 comprise side-firing LEDs such that the light is emitted from a side of the nine LEDs 406 rather than straight up. The side-firing LEDs ensure that the emitted light is directed towards a particular direction and is not getting wasted in the surroundings. Furthermore, the nine LEDs 406 may be Red, Green, and Blue (RGB) LEDs thereby facilitating in displaying different operational states of the printing device 400 using a combination of the RGB LEDs.

In an example implementation, the printing device 400 may include a light guide 408 having an L-shaped substrate 408 to transmit the light emitted from the light source 404 to the light bar 402. In an example, the light guide 408 is similar to the light guides 100, 200, and 308 as described with reference to FIGS. 1, 2, and 3 respectively. The L-shaped substrate facilitates in creating a longer path for the light emitted from the light source 404 to ensure that the light projected on the light bar 402 is evenly spread.

The L-shaped substrate includes a first end 410 to receive light emitted by the light source 404. Further, the L-shaped substrate 408 includes a second end 412 to output diffused light, based on the light received at the first end 410, to illuminate the light bar 402 of the electronic device 400. Further, the L-shaped substrate may have a length ‘L’ of about 19 millimeters. In an example, as the length ‘L_{B}’ of the light bar 402 is 225 mm, a ratio of the length of the L-shaped substrate to the length ‘L_{B}’ of the light bar 402 is in a range of about 1:6 to about 1:12.

In an example, the L-shaped substrate may include a bend profile 414 between the first end 410 and the second end 412. In operation, the light entering through the first end 410 is incident on an inner surface of the bend profile 414 for being directed towards the second end 412. The bend profile 414 facilitates in focusing the reflected incident light towards the second end 412. In the present ample, a point on a curve of the bend profile 414 subtends an angle θ (not shown) with respect to a side wall (not shown) of the L-shaped substrate. For example, the angle θ may be in a range of about 43 degrees to about 65 degrees.

Although examples for the present disclosure have been described in language specific to structural features and/or methods, it is to be understood that the appended claims are not limited to the specific features or methods described herein. Rather, the specific features and methods are disclosed and explained as examples of the present disclosure.

We claim:

1. A light guide for a printing device comprising:
a substrate having,
a first end to receive light emitted from a light source; and
a second end to output diffused light, based on the light received at the first end,
wherein the substrate has a bend profile such that the light entering the substrate through the first end is reflected towards the second end by an inner surface of a bend, and
wherein a ratio of a length of the substrate to a width of the diffused light at the second end is in a range of about 1:6 to about 1:12.

2. The light guide as claimed in claim 1, wherein the substrate has a thickness of about 1.8 millimeters (mm).

3. The light guide as claimed in claim 1, wherein a point on a curve of the bend profile subtends an angle θ, in a range of about 43 degrees to about 65 degrees, with respect to a side wall of the substrate.

4. The light guide as claimed in claim 1, wherein the substrate is made of a styrene-acrylonitrile (SAN) material.

5. The light guide as claimed in claim 1, wherein the substrate has an L-shape and a length of about 19 millimeters (mm).

6. A printing device comprising:
a light bar to indicate an operational state of the printing device;
a light source having light-emitting diodes (LEDs) of same pitch; and
a substrate having,
a first end to receive light emitted from the light source; and
a second end to output diffused light, based on the light received at the first end, to illuminate the light bar,
wherein the substrate has a bend profile such that the light entering the substrate through the first end is reflected towards the second end by an inner surface of a bend, and
wherein a ratio of a length of the substrate to a length of the light bar is in a range of about 1:6 to about 1:12.

7. The printing device as claimed in claim 6, wherein each of the LEDs is an Red, Green. Blue (RGB) LED having a pitch of 18 millimeters (mm).

8. The printing device as claimed in claim 6, wherein the LEDs comprise side-firing LEDs.

9. The printing device as claimed in claim 6, wherein a ratio of the, number of LEDs to a length of the light bar is in a range of about 1:25 to about 1:30.

10. The printing device as claimed in claim 6, wherein the substrate has an L-shape with a length of about 19 millimeters (mm).

11. The printing device as claimed in claim 6, wherein each of the LEDs has a width of about 3.2 millimeters (mm).

12. An electronic device comprising:
a light bar to indicate an operational state of the electronic device, wherein the light bar has a length of about 225 millimeters (mm);
a light source having nine light-emitting diodes (LEDs) having a pitch of 18 mm;
an L-shaped substrate having a length of 9 mm, the L-shaped substrate comprising:
a first end to receive light emitted from the light source; and
a second end to output diffused light, based on the light received at the first end, to illuminate the light bar
wherein the L-shaped substrate has a bend profile such that the light entering the L-shaped substrate through the first end is reflected towards the second end by an inner surface of a bend, and
wherein a ratio of a length of the L-shaped substrate to a length of the light bar is in a range of about 1:6 to about 1:12.

13. The electronic device as claimed in claim 12, wherein each of the nine LEDs is about 3.2 mm wide.

14. The electronic device as claimed in claim 12, wherein the nine LEDs comprise side-firing LEDs.

15. The electronic device as claimed in claim 12, wherein a point on a curve of the bend profile subtends an angle θ with respect to a side wall of the substrate, wherein the angle θ is in a range of about 43 degrees to about 65 degrees.
